(19) United States
(12) Patent Application Publication
(10) Pub. No.: US 2026/0349468 A1
(43) Pub. Date: Nov. 5, 2026

(54) HINGE MECHANISM

(71) Applicant: COMPAL ELECTRONICS, INC., Taipei City (TW)

(72) Inventors: Che-Hsien Lin, Taipei City (TW); Che-Hsien Chu, Taipei City (TW); Hao-Wei Hu, Taipei City (TW)

(73) Assignee: COMPAL ELECTRONICS, INC., Taipei City (TW)

(21) Appl. No.: 19/536,263

(22) Filed: Feb. 11, 2026

Related U.S. Application Data
(60) Provisional application No. 63/798,536, filed on May 1, 2025.

(51) Int. Cl. G06F 1/16

(52) U.S. Cl. CPC G06F 1/1616; G06F 1/1641; G06F 1/1681

(57) ABSTRACT

A hinge mechanism applicable to an electronic device is provided. Two bodies of the electronic device are pivoted relatively to be folded or unfolded via the hinge mechanism. The hinge mechanism includes a fixed frame, a rotating shaft, a supporting frame, and an arcuate gear rack. The rotating shaft is pivoted to the fixed frame and has an external gear. The supporting frame is slidably coupled to the fixed frame and has an arcuate slot. The arcuate gear rack is assembled to the arcuate slot and movably engaged with the external gear. The supporting frame slides relative to the fixed frame and drives the rotating shaft to rotate through the arcuate gear rack and external gear, so that the supporting frame pivots relative to the fixed frame along a virtual axis.

### CROSS-REFERENCE TO RELATED APPLICATION

This application claims the priority benefit of U.S. provisional application serial no. 63/798,536, filed on May. 1, 2025. The entirety of the above-mentioned patent application is hereby incorporated by reference herein and made a part of this specification.

### BACKGROUND

### Technical Field

The disclosure relates to a hinge mechanism.

### Related Art

Existing notebook computers include a display screen, a host, and a hinge module. The display screen and the host are pivoted to each other through the hinge module to facilitate being folded or unfolded. However, a pivot shaft is usually used as a physical rotation axis in existing hinge modules, and space needs to be reserved between the display screen and the host to avoid interference between the display screen and the host during the rotation process.

Therefore, when the notebook computer is switched to an expanded state, a gap is generated. It is impossible to hide the partial hinge module located between the display screen and the host, which makes the expanded notebook computer have an unaesthetic disadvantage. For this reason, developing a seamless hinge to reduce the gap between the display screen and the host in the expanded state and to hide the hinge to achieve aesthetic and size reduction effects has become an important development goal.

However, the seamless hinge is limited by mechanism design and has situations that are difficult to process. For example, the main driving structure is easily obstructed by surrounding structures which hinders processing. Therefore, structural adjustments need to be made to facilitate simplifying manufacturing processes and reducing manufacturing costs.

### SUMMARY

The disclosure provides a hinge mechanism, which reduces manufacturing complexity and costs through reconfiguration of a partial structure.

A hinge mechanism of the disclosure is applicable to an electronic device. Two bodies of the electronic device are pivoted relatively to be folded or unfolded via the hinge mechanism. The hinge mechanism includes a fixed frame, a rotating shaft, a supporting frame, and an arcuate gear rack. The rotating shaft is pivoted to the fixed frame and has an external gear. The supporting frame is slidably coupled to the fixed frame and has an arcuate slot. The arcuate gear rack is assembled to the arcuate slot and movably engaged with the external gear. The supporting frame slides relative to the fixed frame, and drives the rotating shaft to rotate through the arcuate gear rack and the external gear, so that the supporting frame pivots relative to the fixed frame along a virtual axis.

A hinge mechanism of the disclosure is applicable to an electronic device. Two bodies of the electronic device pivot are pivoted relatively to be folded or unfolded via the hinge mechanism. The hinge mechanism includes a fixed frame, a rotating shaft, a supporting frame, and an arcuate gasket. The rotating shaft is pivoted to the fixed frame and has an external gear. The supporting frame has an arcuate slot and an arcuate gear rack adjacent to each other. The arcuate gear rack is movably engaged with the external gear. The arcuate gasket is assembled to the arcuate slot to slidably couple to the fixed frame. The supporting frame is adapted to slide relative to the fixed frame, and drives the rotating shaft to rotate through the arcuate gear rack and the external gear, so that the supporting frame pivots relative to the fixed frame along a virtual axis.

Based on the above, in order to reduce the manufacturing complexity of the hinge mechanism, the supporting frame of the hinge mechanism is divided into different structural components. In an embodiment, the supporting frame is provided with the arcuate gear rack and the arcuate slot, and the arcuate gasket is assembled to the arcuate slot. In another embodiment, the arcuate gear rack is assembled to the arcuate slot.

Regardless of which of the aforementioned approaches is used, both may allow the assembled supporting frame to smoothly slide and couple to the fixed frame, and also allow the arcuate gear rack to smoothly engage with the external gear of the rotating shaft. Therefore, under the premise of ensuring the operation of the hinge mechanism, the processing complexity is reduced through the structurally detachable characteristics of the supporting frame. In other words, the aforementioned approaches of effectively simplifying the manufacturing process of the hinge mechanism lower manufacturing costs.

### BRIEF DESCRIPTION OF THE DRAWINGS

FIG. 1 is a top view of an electronic device according to an embodiment of the disclosure.

FIG. 2 is a schematic view of the electronic device of FIG. 1 in another state.

FIGS. 3 and 4 respectively illustrate schematic views of a hinge mechanism in different states.

FIG. 5 is an exploded view of a hinge mechanism.

FIGS. 6-8 illustrate cross-sectional views of a hinge mechanism in an expanded state at different locations.

FIG. 9 is a schematic view of a hinge mechanism according to another embodiment of the disclosure.

FIG. 10 is an exploded view of the hinge mechanism of FIG. 9.

FIG. 11 illustrates some components of FIG. 10 from another perspective.

### DESCRIPTION OF THE EMBODIMENTS

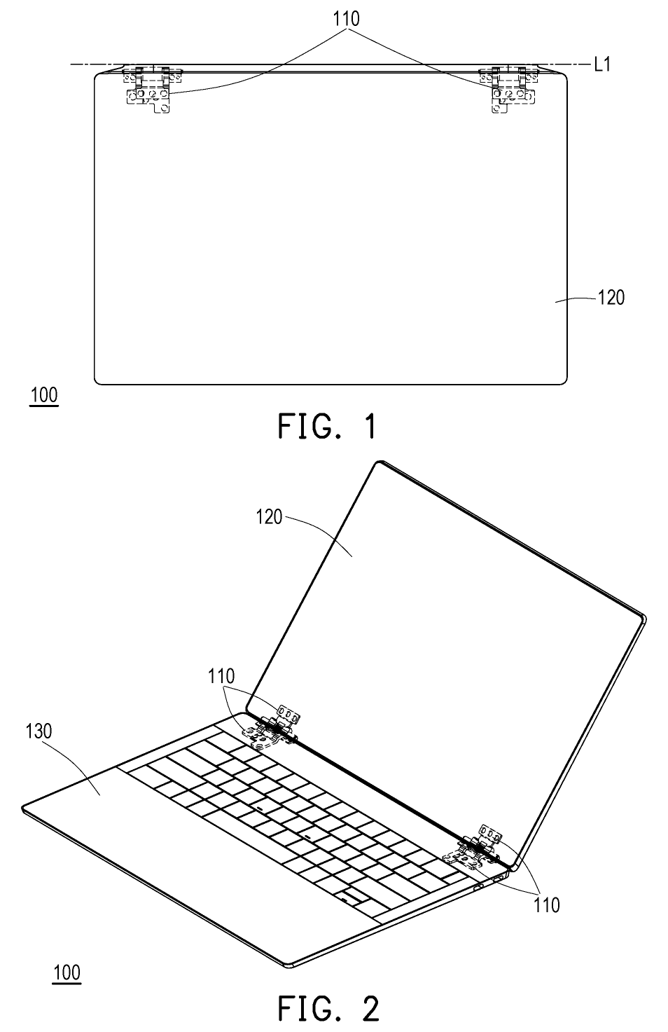

FIG. 1 is a top view of an electronic device according to an embodiment of the disclosure. FIG. 2 is a schematic view of the electronic device of FIG. 1 in another state. Referring to FIGS. 1 and 2 together, an electronic device 100 of this embodiment, for example, a notebook computer, includes two bodies 120, 130 and a hinge mechanism 110. The hinge mechanism 110 is connected between the bodies 120, 130, so that the bodies 120, 130 are pivoted relatively to be folded or unfolded via the hinge mechanism 110.

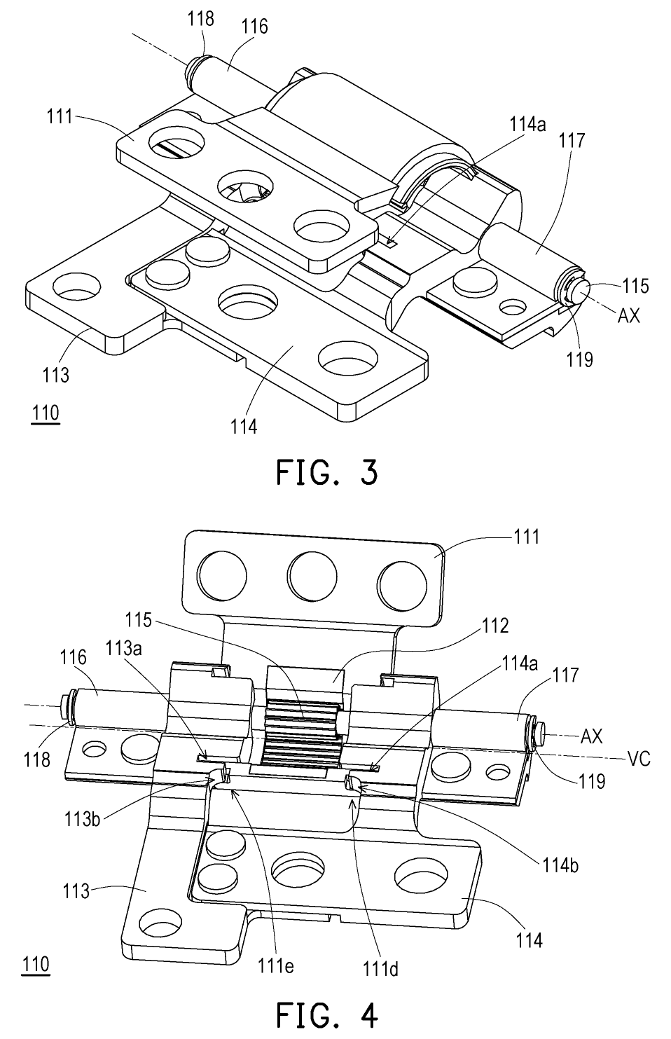

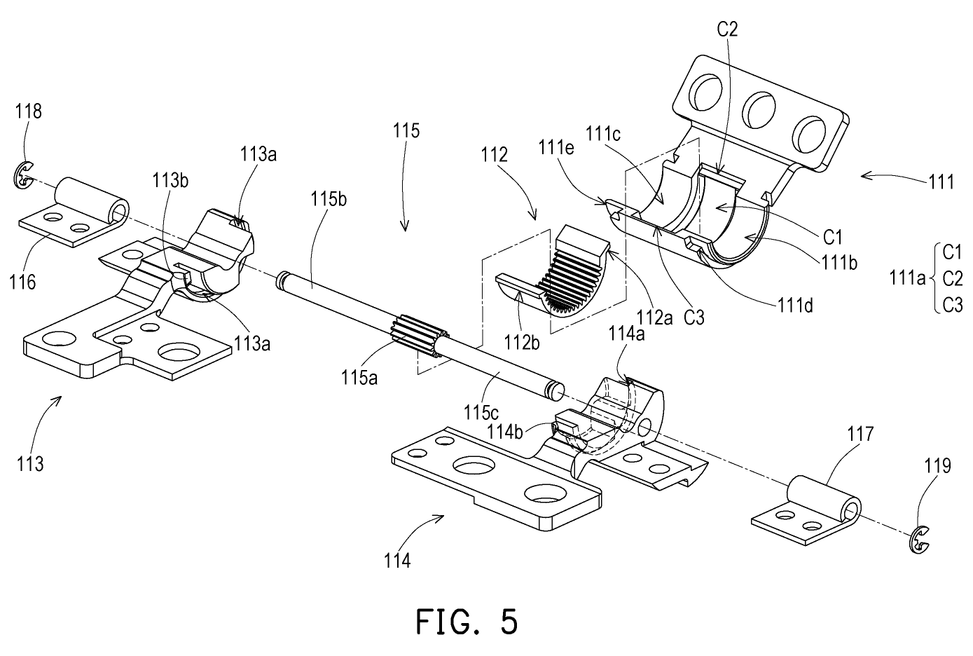

FIGS. 3 and 4 respectively illustrate schematic views of a hinge mechanism in different states. FIG. 5 is an exploded view of a hinge mechanism. Referring to FIGS. 3 to 5 together, the hinge mechanism 110 of this embodiment includes fixed frames 113, 114, a rotating shaft 115, a supporting frame 111, and an arcuate gear rack 112. The rotating shaft 115 is pivoted to the fixed frames 113, 114 and has an external gear 115a. The supporting frame 111 is slidably coupled to the fixed frames 113, 114 and has an arcuate slot 111a. The arcuate gear rack 112 is assembled to the arcuate slot 111a and movably engaged with the external gear 115a of the rotating shaft 115. The supporting frame 111 slides relative to the fixed frames 113, 114, and drives the rotating shaft 115 to rotate through the arcuate gear rack 112 and the external gear 115a, so that the supporting frame 111 pivots relative to the fixed frames 113, 114 along a virtual axis VC.

Through a planetary gear-like structure formed by the external gear 115a and the arcuate gear rack 112, the hinge mechanism 110 has a virtual axis VC serving as a rotation axis, which enables the hinge mechanism 110 to be completely embedded in the bodies 120, 130 to form a compact structure, and thereby improves the space utilization of the bodies 120, 130. When the electronic device 100 is in a folded state, the bodies 120, 130 may be flush with the hinge mechanism 110 along a straight line L1 as shown in FIG. 1, which also represents that the bodies 120, 130 may further advance to achieve the technical characteristics of becoming thinner and lighter.

From FIGS. 3-5, it may be further known that the hinge mechanism 110 of this embodiment has two fixed frames 113, 114 that may be assembled with each other, and respectively have arcuate tracks 113a, 114a. The rotating shaft 115 is respectively disposed through the fixed frames 113, 114, so that the external gear 115a is located between the fixed frames 113, 114 and smoothly coupled to the arcuate gear rack 112. Furthermore, the hinge mechanism 110 further includes torque components 116, 117 and fasteners 118, 119. The torque components 116, 117 are assembled to the fixed frames 113, 114 for the two shaft parts 115b, 115c of the rotating shaft 115 to pivot and provide the required torque during pivoting, while the fasteners 118, 119 fasten the ends of the shaft parts 115b, 115c to position the rotating shaft 115 on the fixed frames 113, 114. In addition, the supporting frame 111 of this embodiment further has a pair of arcuate side wings 111b, 111c, adjacent to opposite sides of the arcuate slot 111a and coupled to the arcuate tracks 113a, 114a of the fixed frames 113, 114.

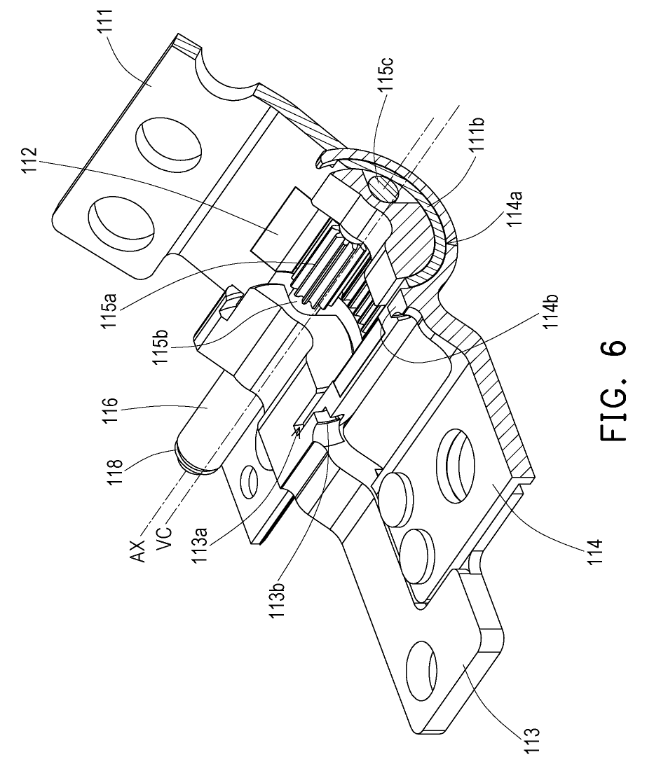

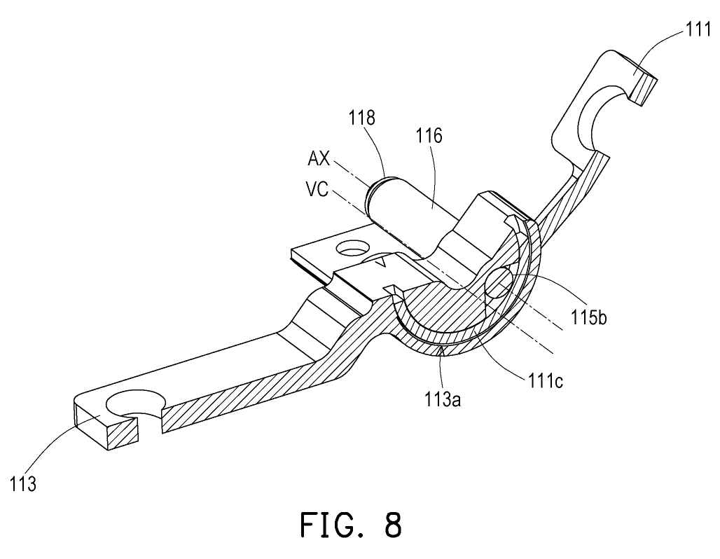

FIGS. 6-8 illustrate cross-sectional views of a hinge mechanism in an expanded state at different locations. Please refer to FIGS. 6-8 together and compare with FIG. 5. In addition to the component relationships that may be clearly understood from FIG. 5, based on the configuration relationships of the aforementioned components and the generated motion mode, the rotating shaft 115 substantially rotates around the virtual axis VC, where the rotating shaft 115 has an axis AX, and the axis AX and the virtual axis VC are different from each other but parallel. Meanwhile, the ends of the arcuate side wings 111b, 111c of this embodiment respectively have stopping parts 111d, 111e corresponding to stopper protrusions 113b, 114b located at the ends of the arcuate tracks 113a, 114a, which allows the supporting frame 111, after pivoting and expanding relative to the fixed frames 113, 114, to provide stopping points (endpoints) for the pivoting stroke through mutual interference between the stopping parts 111d, 111e and the stopper protrusions 113b, 114b, thereby avoiding the supporting frame 111 separating from the fixed frames 113, 114.

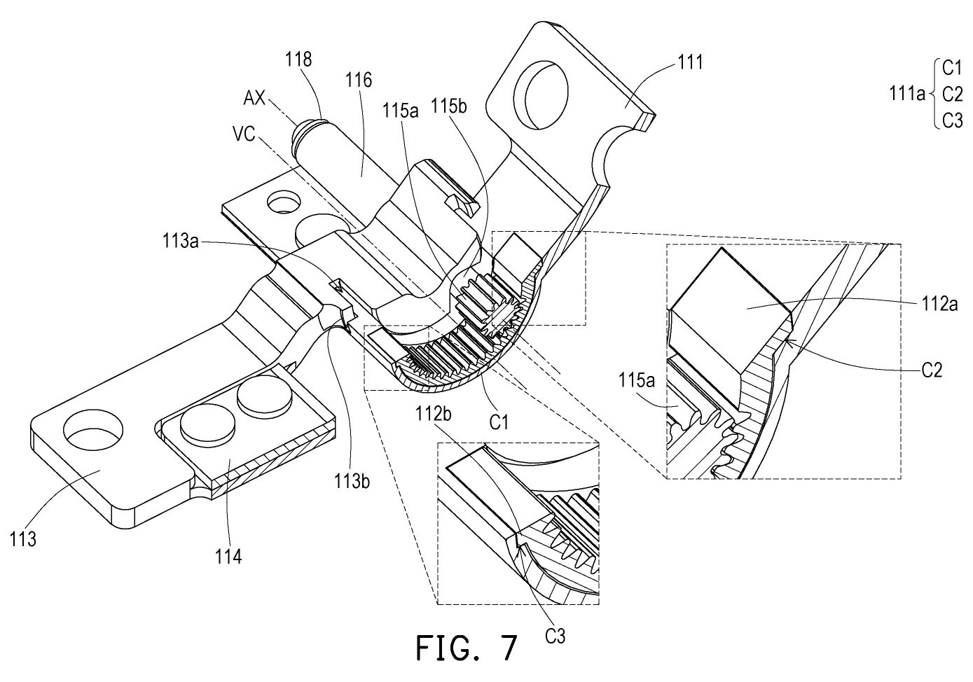

Referring to FIGS. 5 and 7 again, in this embodiment, the arcuate slot 111a includes a supporting part C1 and pawl parts C2, C3 located at opposite ends of the supporting part C1, while the arcuate gear rack 112 also has two end parts 112a, 112b corresponding to each other. By engaging the end part 112a in the pawl part C2 and engaging the end part 112b in the pawl part C3, the arcuate gear rack 112 may be smoothly assembled to the arcuate slot 111a. Here, a surface of the arcuate slot 111a is lower than surfaces of the arcuate side wings 111b, 111c, so that the arcuate slot 111a becomes a recess between the arcuate side wings 111b, 111c on both sides. When the arcuate gear rack 112 is assembled to the arcuate slot 111a, a (gear) top surface of the arcuate gear rack 112 is equal to or lower than the surfaces of the arcuate side wings 111b, 111c. That is, when observing the arcuate gear rack 112 from a side view angle from the arcuate side wing 111b or the arcuate side wing 111c, the arcuate gear rack 112 may substantially be hidden between the arcuate side wings 111b, 111c, which may effectively allow the hinge mechanism 110 to achieve a more compact configuration effect with a “retracted” pivoting drive structure. Meanwhile, since the arcuate gear rack 112 is processed first and then assembled, the difficulty of processing a rack structure on the arcuate side wings 111b, 111c may be greatly reduced. In other words, the arcuate gear rack 112 is another element independent of the arcuate slot 111a, and may also be designed to be detachable according to design requirements to facilitate user operation.

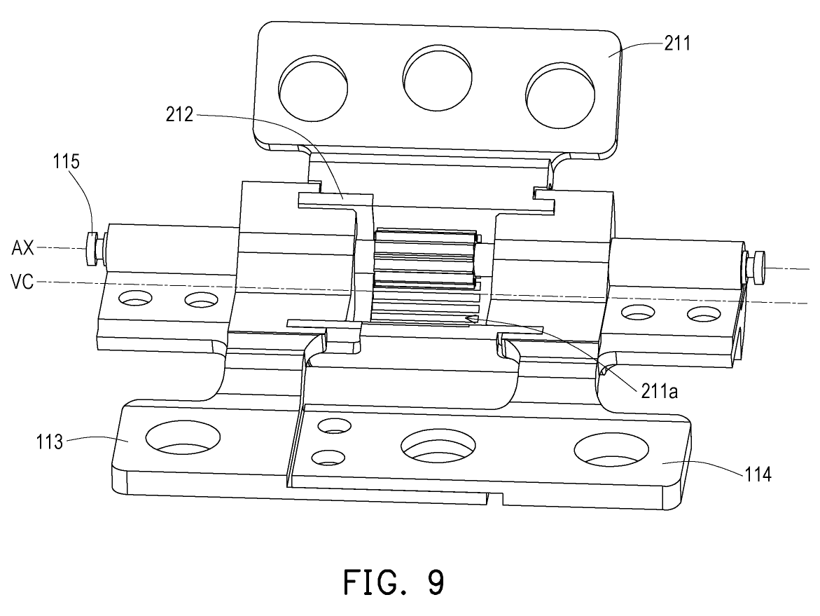

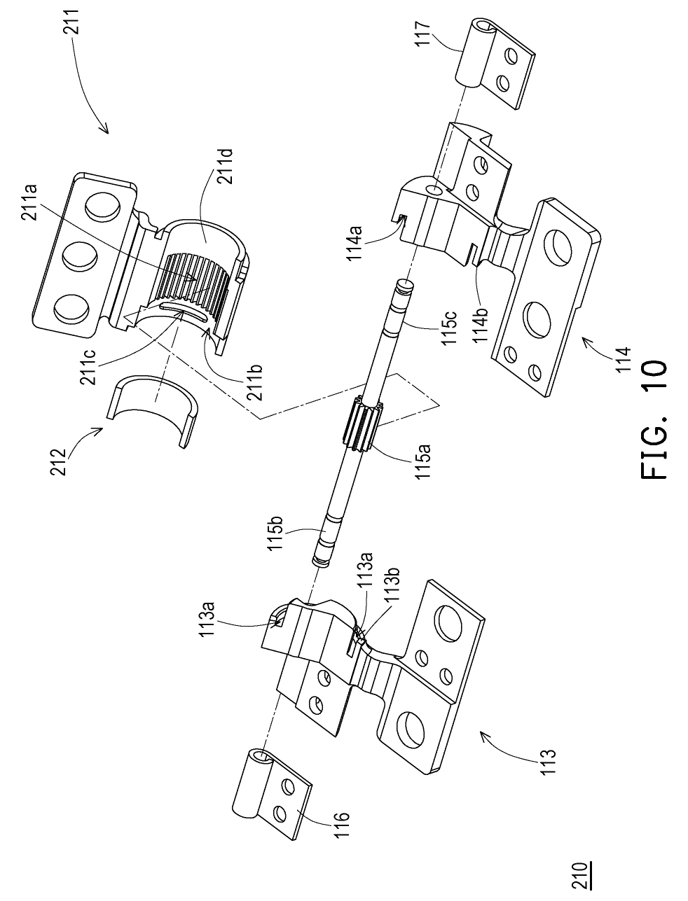

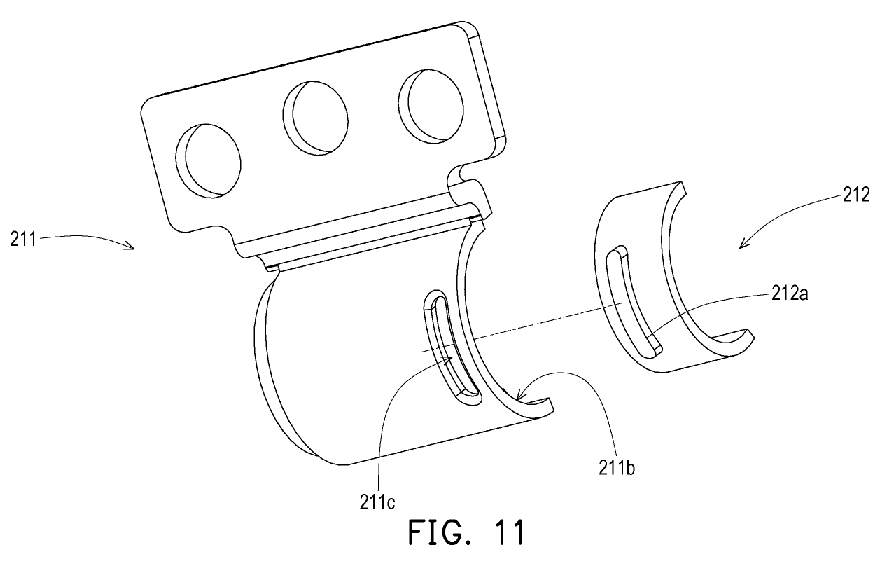

FIG. 9 is a schematic view of a hinge mechanism according to another embodiment of the disclosure. FIG. 10 is an exploded view of the hinge mechanism of FIG. 9. FIG. 11 illustrates some components of FIG. 10 from another perspective. Referring to FIGS. 9-11 together, in this embodiment, a hinge 210 includes fixed frames 113, 114, a rotating shaft 115, a supporting frame 211, and an arcuate gasket 212. The rotating shaft 115 is pivoted to the fixed frames 113, 114 and has an external gear 115a. The supporting frame 211 has an arcuate slot 211b and an arcuate gear rack 211a adjacent to each other. The arcuate gear rack 211a movably engages with the external gear 115a. The arcuate gasket 212 is assembled to the arcuate slot 211b to slidably couple with the fixed frames 113, 114 together. The supporting frame 211 is adapted to slide relative to the fixed frames 113, 114, and drives the rotating shaft 115 to rotate through the arcuate gear rack 211a and the external gear 115a, so that the supporting frame 211 pivots relative to the fixed frames 113, 114 along the virtual axis VC.

The same reference numerals are used here to indicate the same components between this embodiment and the aforementioned embodiments, so the related features are not repeated again. Different from the aforementioned embodiment which removes the arcuate gear rack 112 from the supporting frame 111, this embodiment instead removes one of the arcuate side wings 111b, 111c, which is the arcuate gasket 212 shown in this embodiment. Here, a surface of the arcuate slot 211b is lower than a top surface of the arcuate gear rack 211a, while a top surface of the arcuate gear rack 211a is equal to or lower than a surface of the arcuate gasket 212. In other words, for the supporting frame 211, in this embodiment, one side surface of the arcuate gear rack 211a may be exposed by removing the arcuate gasket 212, so the processing of the arcuate gear rack 211a may be performed on the exposed side. Conversely, without the removable structure of the arcuate gasket 212, the same dilemma of being unable to easily process the arcuate gear rack 211a may be created due to directly facing the supporting frame 211.

In another aspect, as shown in FIG. 11, the arcuate slot 211b of this embodiment has a hole 211c, and a convex surface of the arcuate gasket 212 has a rib 212a. The arcuate gasket 212 is engaged in the hole 211c by the rib 212a and assembled to the arcuate slot 211b. Certainly, in other embodiments not shown, in addition to the assembly structures described in the aforementioned embodiment and this embodiment for the structural component (that is, the arcuate gear rack 112 or the arcuate gasket 212) to be assembled with the supporting frame 111 or 211, the user may also complete the assembly process of the structural component and the supporting frames 111, 211 through known connection technologies, such as attachment or adhesion.

To sum up, in the aforementioned embodiments of the disclosure, in order to reduce the manufacturing complexity of the hinge mechanism, the supporting frame of the hinge mechanism is divided into different structural components. In an embodiment, the supporting frame is provided with the arcuate gear rack and the arcuate slot, and the arcuate gasket is assembled to the arcuate slot. In another embodiment, the arcuate gear rack is assembled to the arcuate slot. The former embodiment may allow the arcuate gear rack to be processed first and then assembled to the supporting frame. The latter embodiment, after removing the arcuate gasket, may obviously expose the side surface of the arcuate gear rack, so the arcuate gear rack may be processed through the side surface, which is obviously simpler and more convenient than directly facing and processing the arcuate gear rack. Therefore, the processing difficulty of the arcuate gear rack is also reduced.

However, regardless of which of the aforementioned approaches is used, both may allow the assembled supporting frame to smoothly slide and couple to the fixed frame, and also allow the arcuate gear rack to smoothly engage with the external gear of the rotating shaft. Thus, under the premise of ensuring the operation of the hinge mechanism, the processing complexity is reduced through the structurally detachable characteristics of the supporting frame. In other words, the aforementioned approaches of effectively simplifying the manufacturing process of the hinge mechanism lower manufacturing costs.

What is claimed is:

1. A hinge mechanism applicable to an electronic device, wherein two bodies of the electronic device are pivoted relatively to be folded or unfolded via the hinge mechanism, the hinge mechanism comprising:
a fixed frame;
a rotating shaft, pivoted to the fixed frame and having an external gear;
a supporting frame, slidably coupled to the fixed frame and having an arcuate slot; and
an arcuate gear rack, assembled to the arcuate slot and movably engaged with the external gear, wherein the supporting frame slides relative to the fixed frame, and drives the rotating shaft to rotate through the arcuate gear rack and the external gear, so that the supporting frame pivots relative to the fixed frame along a virtual axis.

2. The hinge mechanism according to claim 1, wherein the supporting frame further comprises an arcuate side wing adjoining the arcuate slot and coupled to an arcuate track of the fixed frame.

3. The hinge mechanism according to claim 1, wherein the supporting frame further comprises a pair of arcuate side wings adjoining opposite sides of the arcuate slot and coupled to a pair of arcuate tracks of the fixed frame.

4. The hinge mechanism according to claim 1, wherein the rotating shaft further comprises a shaft part pivoted to the fixed frame, and the shaft part and the external gear are coaxial.

5. The hinge mechanism according to claim 2, wherein a surface of the arcuate slot is lower than a surface of the arcuate side wing, and a top surface of the arcuate gear rack is equal to or lower than the surface of the arcuate side wing.

6. A hinge mechanism applicable to an electronic device, wherein two bodies of the electronic device are pivoted relatively to be folded or unfolded via the hinge mechanism, the hinge mechanism comprising:
a fixed frame;
a rotating shaft, pivoted to the fixed frame and having an external gear;
a supporting frame, having an arcuate slot and an arcuate gear rack adjacent to each other, the arcuate gear rack being movably engaged with the external gear; and
an arcuate gasket, assembled to the arcuate slot to slidably couple to the fixed frame, wherein the supporting frame is adapted to slide relative to the fixed frame, and drives the rotating shaft to rotate through the arcuate gear rack and the external gear, so that the supporting frame pivots relative to the fixed frame along a virtual axis.

7. The hinge mechanism according to claim 6, wherein a surface of the arcuate slot is lower than a top surface of the arcuate gear rack, and a top surface of the arcuate gear rack is equal to or lower than a surface of the arcuate gasket.

8. The hinge mechanism according to claim 6, wherein the fixed frame has an arcuate track, and the arcuate slot and the arcuate gasket are coupled to the arcuate track.

9. The hinge mechanism according to claim 6, wherein the supporting frame further comprises an arcuate side wing, the arcuate gear rack is located adjacent to and between the arcuate gasket and the arcuate side wing, and the arcuate gasket and the arcuate side wing are respectively slidably coupled to a pair of arcuate tracks of the fixed frame.

10. The hinge mechanism according to claim 6, wherein the arcuate slot has a hole, a convex surface of the arcuate gasket has a rib, and the arcuate gasket is engaged in the hole by the rib and assembled to the arcuate slot.

11. The hinge mechanism according to claim 6, wherein the rotating shaft further comprises a shaft part pivoted to the fixed frame, and the shaft part and the external gear are coaxial.
